(19) United States
(12) Patent Application Publication
(10) Pub. No.: US 2009/0194459 A1
(43) Pub. Date: Aug. 6, 2009

(54) Fuel processing of feedstocks having components harmful to hydrodesulfurization

(76) Inventors: Antonio M. Vincitore, South Windsor, CT (US); Peter F. Foley, Manchester, CT (US); Derek W. Hildreth, Manchester, CT (US); John L. Preston, Hebron, CT (US); Stephen G. Pixton, South Windsor, CT (US); Nancy P. Foley, Manchester, CT (US)

Correspondence Address: M. P. Williams, 210 Main Street, Manchester, CT, 06042, US

(21) Appl. No.: 12/321,261

(22) Filed: Jan. 16, 2009

Related U.S. Application Data
(63) Continuation-in-part of application No. PCT/US06/30658, filed on Aug. 3, 2006.

(51) Int. Cl. C10G 67/00; B01J 19/00

(52) U.S. Cl. 208/97; 422/211; 422/105

(57) ABSTRACT

A reformer system (11) having a hydrodesulfurizer (12) provides desulfurized natural gas feedstock to a catalytic steam reformer (16), the outflow of which is treated by a water gas shift reactor (20) and optionally a preferential CO oxidizer (58) to provide reformate gas (28, 28a) having high hydrogen and moderate carbon dioxide content. To avoid damage to the hydrodesulfurizer from overheating, any deleterious hydrogen reactants, such as the oxygen in peak shave gas or olefins, in the non-desulfurized natural gas feedstock (35) are reacted (38) with hydrogen (28, 28a; 71) to convert them to alkanes (e.g., ethylene and propylene to ethane and propane) and to convert oxygen to water in a catalytic reactor (38) cooled (46), below a temperature which would damage the reactor, by evaporative cooling with pressurized hot water (42). Hydrogen for the desulfurizer and the hydrogen reactions may be provided as recycle reformate (28, 28a) or from a mini-CPO (67), or from other sources.

This application is a continuation-in-part of copending patent application PCT/US2006/030658, filed Aug. 3, 2006.

### TECHNICAL FIELD

This modality relates to processing of conventional pipeline natural gas feedstock which contains either peak shave gas or high concentrations of olefins such as propylene and ethylene, to convert the oxygen in peak shave gas to water and to convert olefins to ethane and propane, prior to desulfurization in a system which reforms the feedstock and processes it to create reformate gas with a high hydrogen content.

### BACKGROUND ART

Reformation of conventional natural gas feedstocks create reformate gas having a high concentration of hydrogen, usually with further processing to lower the concentrations of CO, providing hydrogen fuel for fuel cells (and other purposes). The processing typically begins with desulfurization in a catalytic hydrodesulfurizer (HDS). Pipeline natural gas, at times, is injected with concentrations as high as 15 volume percent of olefins (CₙH₂ₙ) such as ethylene and/or propylene, such as, for instance, to maintain the heating value of the gas.

Pipeline natural gas is often supplemented with peak shave gas, which typically contains propane diluted with air which contains oxygen; sometimes the peak shave gas includes propylene. The olefins and the oxygen react with hydrogen in the HDS, raising the temperature of the catalyst bed to levels which reduce HDS performance and may cause failure of the HDS. In order to protect against such high temperature excursions, a system controller is typically programmed to respond to excess temperature by reducing the power output of the fuel cell or other reformate consuming system (sometimes referred to as “foldback”), and if the problem is not thereby corrected, by shutting down the fuel cell or other reformate consuming system.

Olefins react over the hydrodesulfurizer catalyst in the presence of hydrogen to form alkanes (CₙH₂ₙ₊₂), generating heat. For example, ethylene (reaction 1) and propylene (reaction 2) react to form ethane and propane:

C₂H₄+H₂→C₂H₆+heat (1)

C₃H₆+H₂→C₃H₈+heat (2)

The oxygen and any propylene in the peak shave gas will also react over the hydrodesulfurizer catalyst in the presence of hydrogen to form water and propane, generating heat. Oxygen and hydrogen (reaction 3) forms water, and propylene reacts with hydrogen (reaction 2) to form propane.

H₂+½O₂→H₂O+heat (3)

These reactions are highly exothermic, for instance, generating temperature rises of up to 28° C. (50° F.) per percent of olefin concentration in the feedstock.

### SUMMARY

This modality may yield a nearly olefin-free and oxygen-free natural gas feedstock, reduce shut downs and foldbacks in apparatus employing reformate hydrogen generated from natural gas feedstock, reform natural gas to provide reformate more reliably, deal with olefins and oxygen in natural gas feedstock in a simple fashion, and improve reliability of desulfurization of natural gas feedstock.

This modality is predicated on realization that excessively exothermic reactions may not only be distanced from delicate, vulnerable catalysts, but may also be carried out in the presence of heat removal so as to avoid excessive temperature spikes that can harm a catalyst.

The present modality maintains the catalytic bed in a catalytic, natural gas hydrodesulfurizer (HDS) below a maximum temperature limit by reacting any deleterious hydrogen reactants such as olefins or oxygen in the feedstock with hydrogen, to convert olefins (such as ethylene or propylene) to corresponding alkanes (such as ethane or propane) and to convert oxygen to water, before the stream of feedstock, now in a non-deleterious form, reaches the hydrodesulfurizer. The advantage of this modality is that the deleterious reactants such as alkanes or oxygen are no longer available to react in the hydrodesulfurizer, and thus do not cause a power plant shutdown or foldback.

This modality further includes reacting the natural gas feedstock in a cooled catalytic reactor: the cooling of the reaction of olefins or oxygen with hydrogen limits the temperature of the reaction processes, thereby avoiding damage to a vessel or catalyst. It also ensures conversion of a high percentage of the olefins in the feedstock to alkanes when operating at rated power.

In this modality, the coolant may be pressurized hot water, which may be on the order of between about 180° C. (325° F.) and about 210° C. (375° F.), or higher; the process is passive in that reaction of more deleterious hydrogen reactants will simply boil more of the coolant water (that is convert more water to steam), which is endothermic and retains the gas exit temperature in the range appropriate for a hydrodesulfurizer inlet temperature.

When deemed necessary or desirable, a post reaction cooler, which may comprise an air cooled radiator or a liquid coolant heat exchanger, may cool the processed feedstock to an appropriate temperature, such as on the order of 90° C. (190° F.), prior to entering the hydrodesulfurizer.

This modality may be practiced (a) with recycled reformate obtained at any point downstream of either a reformer, a shift converter or a preferential oxidizer, fed by the hydrodesulfurizer, or (b) with hydrogen-containing gas from another source, such as a mini catalytic partial oxidizer.

This modality may be implemented as original equipment or conveniently as a retrofit, since it requires only a small adaptation with respect to providing a reactor and hydrogen for converting the deleterious hydrogen reactants. The modality is very simple, allowing the components that perform the hydrogen reactions to remain within the feedstock stream without consequence, even when no deleterious hydrogen reactants are in the feedstock.

Other variations will become apparent in the light of the following detailed description of exemplary embodiments, as illustrated in the accompanying drawings.

### BRIEF DESCRIPTION OF THE DRAWINGS

FIG. 1 is a simplified, stylized, block diagram of a natural gas desulfurization and reforming system employing a first embodiment.

FIG. 2 is a simplified, stylized, block diagram of a natural gas desulfurization and reforming system employing a second embodiment.

FIG. 3 is a simplified, stylized, block diagram of a natural gas desulfurization and reforming system employing a third embodiment.

### MODE(S) OF IMPLEMENTATION

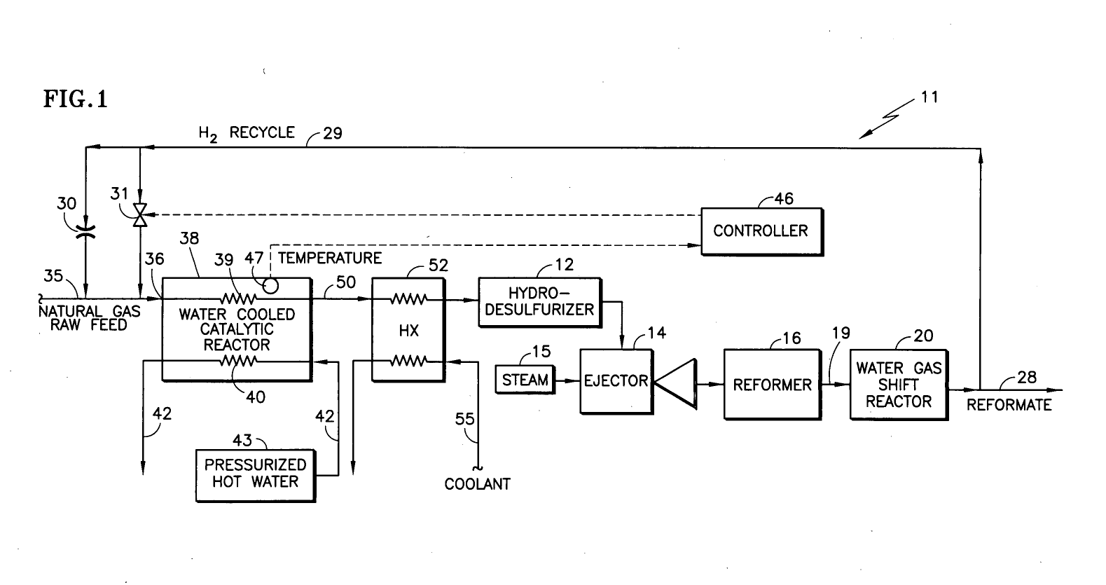

Referring to FIG. 1, a natural gas desulfurization and reformation system 11 includes a hydrodesulfurizer 12, which contains a conventional, commercially available catalyst and sorption material such as zinc oxide. The desulfurized feed is mixed in an ejector 14 with steam from any suitable source 15 and enters an inlet of a reformer 16, which may be a catalytic partial oxidizer, a non-catalytic partial oxidizer, or an autothermal device, but in this embodiment is a catalytic steam reformer, typically utilizing a noble metal, such as Platinum, Palladium, Rhodium, Ruthenium or alloys thereof, or a Nickel catalyst.

From the reformer 16, a process gas containing a high percentage of hydrogen, as well as carbon monoxide and carbon dioxide, is fed over a conduit 19 to a conventional water gas shift reactor 20 that converts a substantial amount of CO and water into CO₂ and hydrogen.

The result is reformate gas in a conduit 28 which contains a high percentage of hydrogen, some CO₂ and other gases, possibly including unreformed hydrocarbons. The hydrogen-containing reformate gas is fed by a conduit 29 through an orifice 30 to provide an adequate flow of hydrogen for desulfurization, when reaction of deleterious hydrogen reactants is not required, and to provide additional hydrogen through a valve 31 when reaction of deleterious hydrogen reactants, such as olefins or oxygen, is required.

The hydrogen and natural gas raw feedstock in a conduit 35 are provided to an inlet 36 of a water cooled catalytic reactor 38, which may comprise a dual coil heat exchanger having catalysts disposed on the surfaces of a primary coil 39, with high pressure hot water in lines 42 from a source 43 circulating through a secondary coil 40. In accordance with the invention, the catalytic reactor 38 can be considered a passive device in terms of controlling operating temperature. Coolant flow from the source 43 is set to control the reactor temperature within an acceptable range given any possible deleterious hydrogen reactant content in the natural gas raw feedstock. A controller 46 adjusts H₂ flow through the valve 31 in response to variations in reactor temperature, within the aforementioned range of temperature, as indicated by a temperature sensor 47. As the reactor temperature increases, the H₂ flow is increased according to a predetermined schedule. As a result, the system feeds enough H₂ to the catalytic reactor to assure conversion of all the olefins and oxygen, while minimizing the H₂ flow when olefin or oxygen content is low or zero.

The temperature of the pressurized hot water from the source may be greater than 180° C. (325° F.), but is in the liquid phase because of being at a pressure on the order of 1030 kPa (150 psi). When the reaction of a deleterious hydrogen reactant with hydrogen raises the temperature above about 180° C. (356° F.), the hot water will boil, producing steam, which is endothermic and keeps the temperature from rising above the vaporization temperature at the pressure of the hot water. This also provides passive control on the temperature within the cooled catalytic reactor 38, so that the catalyst is not harmed and there is no danger to the structural integrity of the vessel.

Maintaining catalyst temperature is a critical function of the water cooled reactor design. Virgin reactor catalyst and in-service catalysts that have been subjected to short term exposure to a feedstock bearing no deleterious hydrogen reactants but containing catalyst poisons, such as sulfur, will initiate the hydrogenation reaction upon exposure to feedstock bearing olefins or peak shave gas at temperatures less than room temperature (21° C.). Some reactor catalysts containing noble metals, when subjected to long term exposure to feedstock bearing no deleterious hydrogen reactants but containing poisons, require an elevated temperature to initiate the hydrogen reaction upon re-introduction of feedstock containing deleterious hydrogen reactants and poisons. This minimum temperature is defined, herein, as the light off temperature.

The light-off temperature is functionally dependent on the inlet gas conditions and the inherent physical/chemical properties of the catalyst. The cooled reactor is designed to maintain the catalyst above the light off temperature required by the selected catalyst to initiate the hydrogen reaction after long term exposure to feedstocks bearing no olefins or peak shave gas but containing poisons, such as sulfur, which may inhibit the reaction at room temperature. The light off temperature should be about 100° C. (212° F.).

A second critical function of the cooled reactor design is to limit the maximum temperature within the catalyst bed to prevent catalyst damage or deactivation and to limit the thermodynamic equilibrium olefin slip to acceptable levels. The cooled reactor design for the exemplary embodiment maintains the catalyst temperature between 100° C. (212° F.) and 310° C. (590°) by using cooling water at an inlet temperature between 160° (320°) and 170° C. (338°).

Another critical design feature of the cooled reactor is that it reduces the deleterious hydrogen reactant content of the feedstock to a level which is consistent with the maximum limits for the down stream equipment. The cooling capacity of the cooled reactor must be sized to absorb the heat release associated with at least this minimum deleterious hydrogen reactant conversion. Typically, the maximum limit for the down stream equipment is set by both the inlet feedstock gas temperature to the HDS, and the maximum HDS catalyst bed temperature limit. Typically, the minimum required deleterious hydrogen reactant conversion is 80%, and the cooled reactor is sized to convert 100% of the deleterious hydrogen reactant and to absorb all of the heat release associated with that conversion level.

The outflow from the cooled reactor 38 in a conduit 50 may exceed the desired inlet temperature of downstream equipment. A heat exchanger may be used to cool the feedstock, in those instances. In the exemplary embodiment, the exit temperature of the reactor 38 may exceed 215° C. (419° F.), which exceeds the desired inlet temperature of the hydrodesulfurizer 12. A heat exchanger 52 is employed in the preferred embodiment of the design to reduce the temperature of the deleterious hydrogen reactant-depleted feedstock to about 100° C. (212° F.). The heat exchanger may comprise an air cooled radiator in most cases, but if necessary, can comprise a heat exchanger cooled by a liquid coolant in a conduit 55. These and other details are selected as may be suitable for any given implementation of the present modality.

Under most power plant operating conditions, heat exchanger 52 is required to cool the feedstock in order to achieve the desired HDS inlet temperature. Heat exchanger 52 may be omitted for those instances where alternative catalysts in reactor 38 or alternative operating conditions are used, which result in an HDS feedstock inlet temperature low enough so that the HDS catalyst bed will not exceed its maximum temperature limit.

A number of other variations may be made in the details of implementation, when incorporating the modality into a system. For instance, instead of the orifice 30, conduit sizing may be used to provide a reduced flow of H₂ when reaction of deleterious hydrogen reactants is not required. In place of the orifice 30, another valve, controllable by the controller 46, may be employed. Or, both functions may be performed by appropriate control of a single valve 31, without the orifice 30.

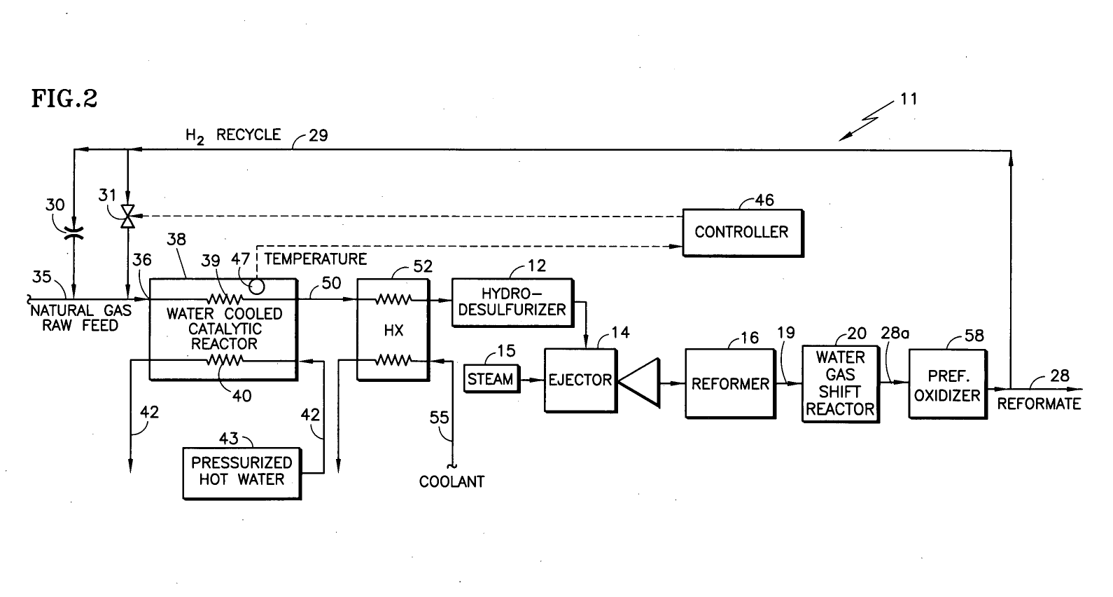

As shown in FIG. 2, in some applications, such as when the reformate will fuel a proton exchange membrane fuel cell, the reformed gas is fed in a conduit 28a to a preferential carbon monoxide oxidizer 58 where additional CO is converted to CO₂. The reformate with lower CO concentrations is available for utilization in the conduit 28 as well as being applied to the orifice 30 and valve 31 by the conduit 29.

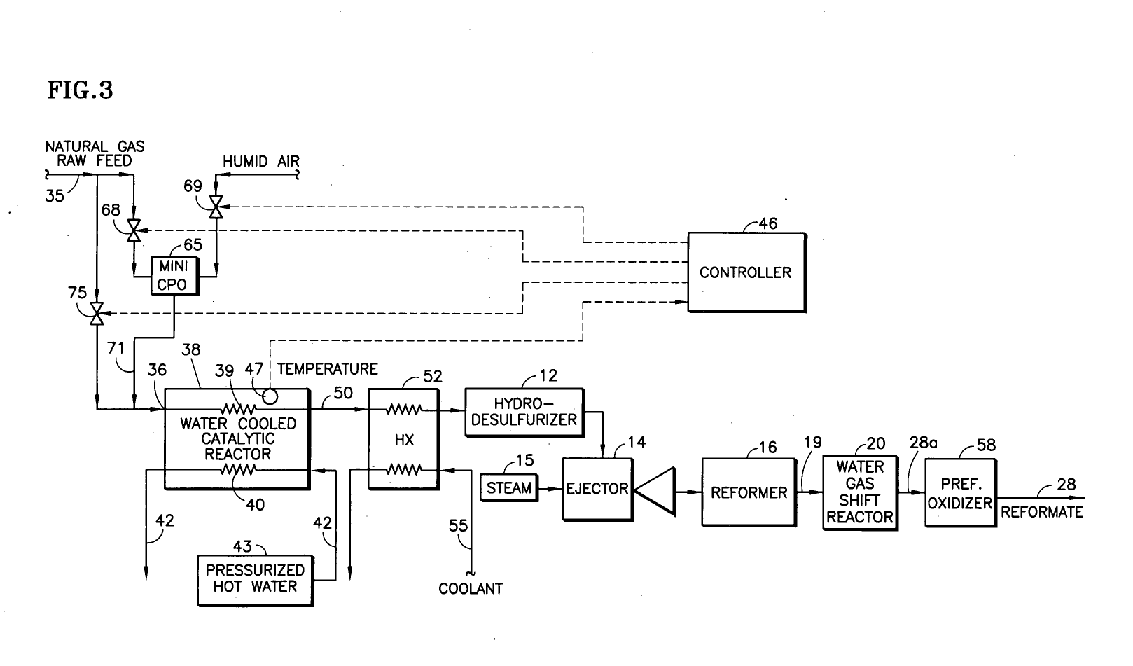

Another embodiment of the invention, illustrated in FIG. 3, does not use recycle hydrogen either for desulfurization or for conversion of deleterious hydrogen reactants. Instead, a mini-catalytic partial oxidizer 65 (mini CPO) receives non-desulfurized natural gas through a valve 68 and humidified air through a valve 69 to produce sufficient hydrogen in a conduit 71 for reaction with any deleterious hydrogen reactants and for hydrodesulfurization of the feedstock. A valve 75 may control the flow of feedstock from the conduit 35 to the inlet 36 of the reactor 38. Hydrogen may be provided to the processes herein from other sources, if desired. Since the mini CPO fuel and air are controlled by the controller 46 via valves 68 and 69, orifice 30 and valve 31 are not needed in this embodiment.

The term “non-deleterious” means having the deleterious hydrogen reactants reduced sufficiently so as to not have excessive temperatures in the hydrodesulfurizer as a result of reactions therewith, which typically requires conversion of at least about 80% of the deleterious hydrogen reactants to alkanes or water, for instance.

The natural gas feedstock in conduit 35 is allowed to flow through the reactor 38 at all times (even when not needed to convert deleterious hydrogen reactants) for mechanical and control simplicity, and to support quicker response to excessive temperatures. The amount of hydrogen is varied for beneficial removal of deleterious hydrogen reactants in accordance with a pre-determined operating temperature range within the catalyst bed of the reactor 38. In this embodiment, the operating temperature range of the reactor 38 is set at 149° C. (300° F.) to 177° C. (350° F.).

Thus, although the invention has been shown and described with respect to exemplary embodiments thereof, it should be understood by those skilled in the art that the foregoing and various other changes, omissions and additions may be made therein and thereto, without departing from the spirit and scope of the invention.

We claim:

1. A fuel processing method characterized by:
pretreating a hydrocarbon feedstock (35) fed to a hydrodesulfurizer (12) by catalytically reacting (38) the feedstock (35) with hydrogen-containing gas (28, 71) to convert deleterious reactants in the feedstock to provide non-deleterious feedstock (50); and
feeding (50, 52) non-deleterious feedstock to the hydrodesulfurizer (12).

2. A method according to claim 1 further characterized in that:
said step of feeding includes cooling (52, 55) the non-deleterious feedstock (50) before said feedstock is fed to the hydrodesulfurizer (12).

3. A method according to claim 1 further characterized in that said catalytically reacting step (38) comprises catalytically reacting hydrocarbon feedstock (35) in a temperature controlled (40, 43) catalytic reactor (38).

4. Apparatus, comprising:
a hydrodesulfurizer (12);
said apparatus characterized by:
means (38) configured to catalytically react hydrocarbon feedstock (35) with hydrogen-containing gas (28, 71) to convert deleterious reactants in the feedstock (50) so as to provide non-deleterious feedstock; and
means (50, 52) for feeding the non-deleterious feedstock to the hydrodesulfurizer.

5. Apparatus according to claim 4 further characterized by:
said means for feeding (50, 52) including means (52, 55) for cooling the non-deleterious feedstock before said feedstock is fed to the hydrodesulfurizer (12).

6. Apparatus according to claim 4 further characterized in that said means (38) configured to catalytically react hydrocarbon gas feedstock (35) comprises a temperature controlled (40, 43) catalytic reactor.

7. A method characterized by:
flowing hydrocarbon feedstock (35) and a predetermined flow (30; 68, 69) of hydrogen-containing gas (28, 71) through a temperature controlled catalytic reactor (38) to a hydrodesulfurizer (12);
monitoring (46, 47) temperature of said catalytic reactor; and
in response to an indication (46, 47) of temperature of said catalytic reactor being above a predetermined operating temperature, providing (31; 68, 69) additional flow of said hydrogen-containing gas to said catalytic reactor to increase conversion of deleterious reactants in the feedstock so as to provide non-deleterious feedstock.

8. A method according to claim 7 further characterized in that:
said step of flowing includes cooling (52, 55) the flow from said catalytic reactor (38) to said hydrodesulfurizer (12).

9. Apparatus, comprising:
a source (35) of hydrocarbon feedstock;
a hydrodesulfurizer (12);
a source of hydrogen-containing gas (28, 71);
characterized by:
a temperature controlled catalytic reactor (38) connected between the source of feedstock and the hydrodesulfurizer;
means (30; 68, 69) for providing a predetermined flow of the hydrogen-containing gas to the catalytic reactor;
means (46, 47) for monitoring temperature of the catalytic reactor; and
means (31; 68, 69) responsive to the monitoring means indicating temperature of the catalytic reactor being above a predetermined operating temperature for providing additional flow of the hydrogen-containing gas to the catalytic reactor to increase conversion of deleterious reactants in the feedstock so as to provide non-deleterious feedstock.

10. Apparatus according to claim 9 further characterized in that:
the catalytic reactor (38) is connected to the hydrodesulfurizer (12) through a cooler (52).

11. Apparatus according to claim 9 further characterized in that:
the temperature controlled catalytic reactor (38) is cooled (39, 40) by coolant (43) having a pressure at which the coolant boils at a temperature near said predetermined operating temperature.

12. Apparatus according to claim 9 further characterized in that:
the source of hydrogen-containing gas (28) includes a steam reformer (16) receiving desulfurized, non-deleterious natural gas from said hydrodesulfurizer (12).

13. Apparatus according to claim 9 further characterized by:
said source (65, 71) of hydrogen gas comprising a catalytic partial oxidizer (65) operated on (a) non-desulfurized hydrocarbon gas from said source (35, 68) and (b) a humid, oxygen-containing gas (69).
